(19) United States
(12) Patent Application Publication
(10) Pub. No.: US 2016/0240338 A1
(43) Pub. Date: Aug. 18, 2016

(54) VACUUM CIRCUIT BREAKER UNDER HIGH PRESSURE

(71) Applicant: ABB Technology AG, Zuerich (CH)

(72) Inventors: Edgar Dullni, Ratingen (DE); Dukkaiappan Subbiah Thevar, Duesseldorf (DE); Knut Rongve, Fyllingsdalen (NO); Markus Bellut, Duesseldorf (DE); Olav Byrkjeland, Bjorndalstrae (NO); Paul Midtun, Bergen (NO); Philipp Masmeier, Duesseldorf (DE); Pravin Futane, Bergen (NO); Tor-Odd Ronhovd, Hordvik (NO)

(21) Appl. No.: 15/052,937

(22) Filed: Feb. 25, 2016

Related U.S. Application Data
(63) Continuation of application No. PCT/EP2014/002321, filed on Aug. 25, 2014.

(30) Foreign Application Priority Data
Aug. 26, 2013 (EP) 13 004 207.0

(51) Int. Cl. H01H 33/664; H01H 33/662

(52) U.S. Cl. CPC H01H 33/664; H01H 33/66207

(57) ABSTRACT

A vacuum circuit breaker for the use in high pressure environments, has at least one vacuum interrupter with at least one moving contact and at least one fixed contact inside the vacuum interrupter, and external contact points at the vacuum interrupter. The vacuum circuit breaker can be used under the high-pressure environmental conditions through the use of at least one vacuum interrupter arranged in a pressure tight container, wherein the electrical contacting is realized via a high voltage bushings through the container wall, and the pressure tight container is at least partially filled with insulating oil.

### CROSS-REFERENCE TO RELATED APPLICATIONS

This application is a continuation of International Application No. PCT/EP2014/002321, filed on Aug. 25, 2014, and claims benefit to European Patent Application No. 13 004 207.0, filed on Aug. 26, 2013, each of which is incorporated in its entirety herein. The International Application was published in English on Mar. 5, 2015, as WO 2015/028140 A1 under PCT Article 21(2).

### FIELD

The invention relates to vacuum circuit breaker for the use in high pressure environments.

### BACKGROUND

A vacuum circuit-breaker contains a sealed vacuum interrupter, which internally has zero pressure and operates against external pressure. The movement of one of the interrupter contacts is transferred through the vacuum tight housing by metallic bellows.

For the use of such circuit breaker in subsea application, the environmental pressure has to be considered.

Since the pressure in a water depth of up to 3000 m exerts a pressure of 300 bar, the vacuum interrupter has to be placed in such, that a withstanding against this high external pressure is given, in order to ensure the usual pressure environment of the vacuum interrupter of 1 bar. At higher pressures, the bellows will be probably destroyed and the driving mechanism will not be able to open the interrupter.

SUMMARY

An aspect of the invention provides a vacuum circuit breaker for use in high pressure environments, the breaker comprising: a vacuum interrupter including a moving contact and a fixed contact inside the vacuum interrupter; and external contact points at the vacuum interrupter, wherein the vacuum interrupter is arranged in a pressure tight container, wherein electrical contacting is realized via high voltage bushings through a container wall, and wherein the pressure tight container includes an insulating oil.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a single phase circuit breaker;

FIG. 2 shows a pressure tight container made out of one piece;

FIG. 3 shows a container made of metal; and

FIG. 4 shows a three phase unit.

### DETAILED DESCRIPTION

An aspect of the invention provides a vacuum circuit breaker for the use in high pressure environments, with at least one vacuum interrupter with at least one moving contact and at least one fixed contact inside the vacuum interrupter, and external contact points at the vacuum interrupter.

So it is an aspect of the invention, to enable vacuum circuit breaker in such, that they can be used under one or more of the environmental conditions discussed in the Background.

An aspect of the invention can address these known issues, by the use of a pressure tight container, which requires insulated high-voltage bushings being able to carry the rated current of the switchgear and withstanding the network voltage incl. fast voltage transients. Putting insulating oil inside the pressure tight container allows reducing the dielectric distances, decreasing the dimensions of the container incl. its wall thickness and designing small and compact bushings. Using a magnetic actuator, a very compact single-phase or three-phase circuit-breaker device can be designed.

So then basic features are, that at least one vacuum interrupter is arranged in a pressure tight container, and that the electrical contacting is realized via high voltage bushings trough the container wall, and that the pressure tight container is filled with insulating oil.

In a further advantageous embodiment, an actuator for the vacuum interrupter is also implemented inside the aforesaid pressure tight container, in common with the vacuum interrupter, like a magnetic actuator.

In a further advantageous embodiment, the circuit breaker is a three phase circuit breaker with at least one vacuum interrupter per phase.

In a further advantageous embodiment, the container is equipped for withstand against an environmental pressure up to 300 bar.

In a further advantageous embodiment, the container itself consists basically of at least one bell-shaped container part.

In a further advantageous embodiment, the container consist of two bell-shaped container parts fixed together oppositely, and that the two container parts are tightly connected pressure tight by an high pressure o-ring sealing.

In a further advantageous embodiment, the sealing is construed redundantly with at least two o-ring seals, arranged concentrically or nearly concentrically.

In a further advantageous embodiment, that the container is at least partly made of insulating material.

In a further advantageous alternative, the container and/or the container elements are made out of steel or aluminum.

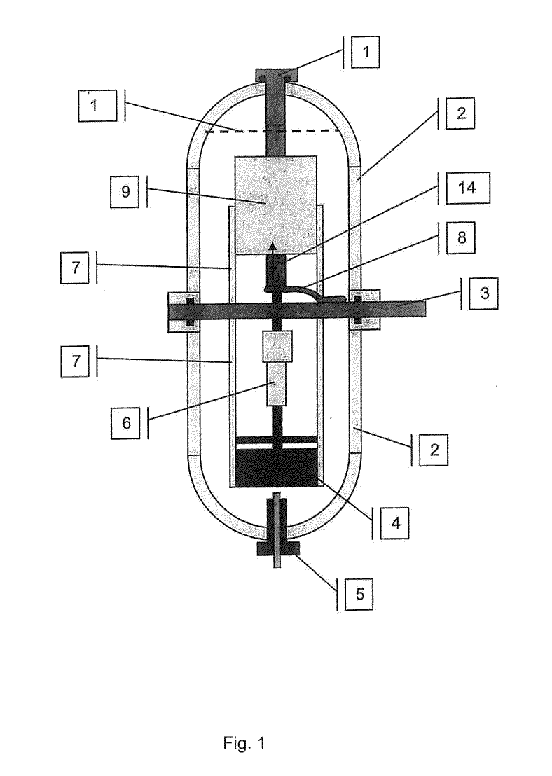

FIG. 1 shows a single-phase circuit-breaker unit with an insulating container 2. This container has to withstand the external pressure of up to 300 bar and is made of insulating material with high tensile strength. Wall thickness and shape is optimized to cope with the high pressure difference. Here, two identical bell-shaped containers 2 are placed on a conducting metal plate 3, which also serves as one of the electrical terminals of the circuit-breaker. The container is sealed against the high pressure environment by appropriate seals e.g. O-rings. One part of the container houses the vacuum interrupter 9 with movable interrupter stem 14 and flexible connection 8 e.g. a copper laminated band to plate 3. The other part of the container houses the magnetic actuator 4 with insulating connection 6 to the movable interrupter stem 14 comprising e.g. the spring, which exerts the necessary contact force to the vacuum interrupter contacts. Vacuum interrupter 9 and magnetic actuator 4 are mounted on an insulating support, which is itself mounted on plate 3. The unit is completed by a conducting metallic bushing 1 sealed against the insulating container e.g. by O-rings or other appropriate seals. A low-voltage bushing 5 feeds in signal and control wires. The pressure tight container is filled with insulating oil such as used in high voltage transformers. The fluid is filled up to some level 10 in order to ensure a pressure of 1 bar and allowing for possible volume changes when parts are moving during opening and closing of the vacuum interrupter.

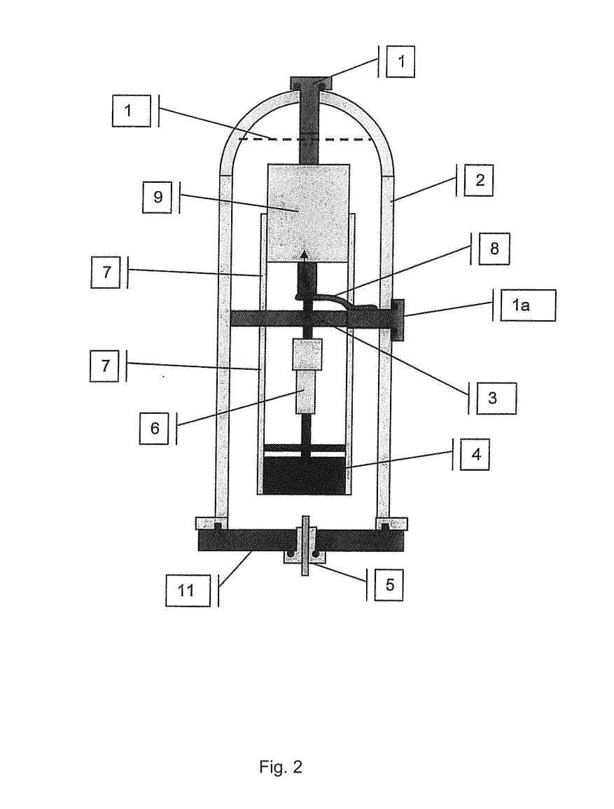

According to FIG. 2, the pressure tight container can be made out of one piece 2. In this case, a metal bushing 1a has to penetrate the container wall from the side serving as one of the terminals of the circuit-breaker. The insulating container 2 has to be tightly closed on one side by a metallic plate carrying a low voltage bushing 5 for signal and control wires. The insulating support 7 holds vacuum interrupter 9 and magnetic actuator 4 and is assembled to plate 3, which is connected to the bushing 1a so that in principle the same functionality is given as in FIG. 1.

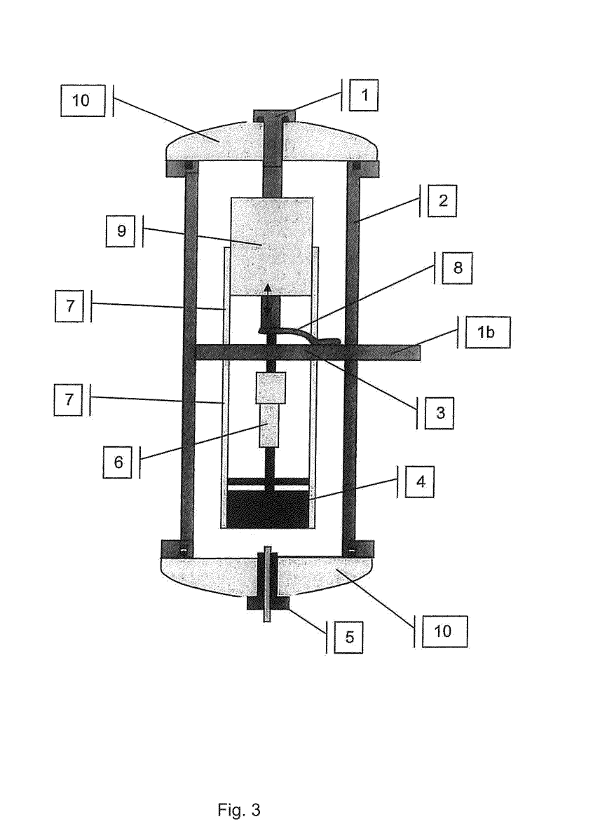

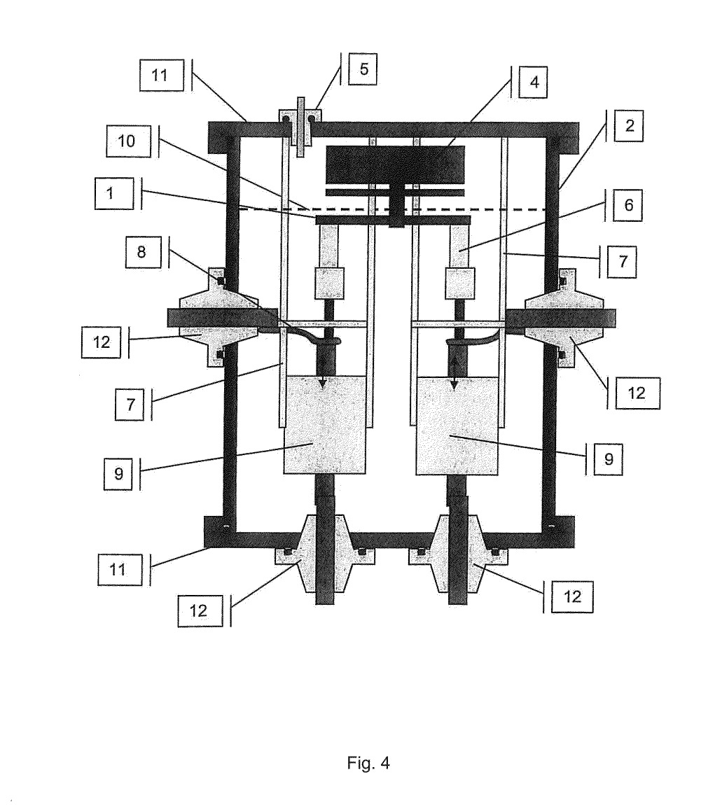

In FIG. 3, the insulating container is replaced by a pressure tight metallic container in the shape of a cylinder. In this particular case, the container walls are on the same potential as one of the terminals of the circuit-breaker. In this case, the terminal 1b needs no bushing or penetration through the wall, since the current conducting abilities of the container wall can be utilized. The required conductivity is provided for lower rated currents by steel walls and for higher rated currents e.g. by aluminum walls. Alternatively, connection 1b may be replaced by a high-voltage bushing similar to part 12 in FIG. 4. The metal container 2 then can be grounded. The metallic cylinder has to be tightly closed on both sides either with insulating caps 11, if the container is on the potential of the terminal, or with metal plates, if the container is on ground potential. Of course, the caps have to be sealed against the high external pressure. The insulating caps can be made from enforced plastic material such as fiber filled polyamide or PEEK. On one side, either a conducting metal bushing 1 or a high-voltage bushing similar to part 12 in embodiment no. 4 serves as second terminal of the circuit-breaker. On the other side a low-voltage bushing 5 feeds in signal and control wires. Otherwise the same functionality is given as in embodiment no. 1. The container is filled with insulating oil.

In FIG. 4 an example is provided, how all embodiments FIGS. 1 to 3 can be converted into a three-phase unit (the third phase is not shown in the diagrams). A three phase unit has the advantage that only one low-voltage bushing is required for signal and control wires and that one single, but of course stronger magnetic actuator can be used for all three vacuum interrupters. This is not possible for separate single-phase units in a pressurized environment. In the shown embodiment, the pressure tight container is made of steel or any other metal with high tensile strength. It requires six high-voltage bushings 12 for the six terminals of the circuit-breaker. These bushings are sealed against the container 2 and withstand the rated voltage levels of the switchgear. Magnetic actuator 4 and vacuum interrupters 9 with all necessary elements are mounted on an insulating support 7, which is fixed to one of the grounded metallic end plates 11. Alternatively, the three bushings penetrating the side wall of the container might also be arranged in the end plate 11, which also carries all three vacuum interrupters. Appropriate conductors have to be designed to connect movable stems of the interrupters to these bushings. One low-voltage bushing 5 feeds in signal and control wires. The container is filled with oil up to some level 10 allowing for pressure and volume compensation. In the shown embodiment, the interrupters 9 and actuator 4 are positioned upside down, the advantage of which is explained below. However, they can also be placed in the same direction as shown in the other embodiments.

FIG. 4 can also be designed with a pressure tight container made of insulating plastic material instead of metal. In this case, the high-voltage bushings 12 may be replaced by simpler conducting bushings as shown as part 1 in FIGS. 1 and 2.

The level of oil inside the container in the FIGS. 1 to 4 has to be filled up to some level 10 in order to allow for volume and temperature changes. If the actuator is placed in the top volume of the container 2 as shown in FIG. 4, this has the advantage that the region without insulating oil i.e. above oil level 10 is on ground potential and no dielectric withstand is required. If the vacuum interrupter is placed on top, the region without oil has to be carefully designed so that the dielectric withstand of insulating parts can never fall below the rated values.

The effect of the compensating air space above the oil level 10 can also be achieved by a completely sealed bellows filled with one bar of air or vacuum allowing for volume compensation.

Alternatively, the pressure tight container might be filled with gas e.g. SF6 of one bar or higher pressure. In this case, a compensating volume is not necessary, since gas is compressible. All dimensions then have to be adapted to the different voltage withstand capability of the used gas. The functionality of the device is the same.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. A vacuum circuit breaker for use in high pressure environments, the breaker comprising:
a vacuum interrupter including a moving contact and a fixed contact inside the vacuum interrupter; and
external contact points at the vacuum interrupter,
wherein the vacuum interrupter is arranged in a pressure tight container,
wherein electrical contacting is realized via high voltage bushings through a container wall, and
wherein the pressure tight container contains an insulating oil.

2. The breaker of claim 1, wherein the pressure tight container is filled with the insulating oil.

3. The breaker of claim 1, further comprising:
an actuator for the vacuum interrupter inside the pressure tight container, in common with the vacuum interrupter.

4. The breaker of claim 3, wherein the actuator is a magnetic actuator.

5. The breaker of claim 1, configured as a three phase circuit breaker including a vacuum interrupter in each phase.

6. The breaker of claim 3, configured as a three phase circuit breaker including a vacuum interrupter in each phase.

7. The breaker of claim 1, wherein the container is configured to withstand an environmental pressure up to 300 bar.

8. The breaker of claim 1, wherein the container includes a bell-shaped container part.

9. The breaker of claim 1, wherein the container consists of at least one bell-shaped container part.

10. The breaker of claim 1, wherein the container consists of two bell-shaped container parts fixed together oppositely, and
wherein the two container parts are connected pressure tight by a high pressure o-ring seal.

11. The breaker of claim 10, wherein the seal is configured redundantly, including at least two o-ring seal, arranged nearly concentrically.

12. The breaker of claim 10, wherein the seal is configured redundantly, including at least two o-ring seal, arranged concentrically.

13. The breaker of claim 1, wherein the container is at least partly made of insulating material.

14. The breaker of claim 1, wherein the container and/or container elements are made out of steel or aluminum.

15. The breaker of claim 1, wherein the container is made of a material including steel.

16. The breaker of claim 1, wherein the container is made of a material including aluminum.

17. The breaker of claim 1, wherein container elements are made of a material including steel.

18. The breaker of claim 1, wherein container elements are made of a material including aluminum.
